(19) United States
(12) Patent Application Publication
(10) Pub. No.: US 2017/0318315 A1
(43) Pub. Date: Nov. 2, 2017

(54) APPARATUS AND METHOD FOR TRANSMITTING CONTENT OVER NETWORK

(71) Applicant: Samsung Electronics Co., Ltd., Suwon-si (KR)

(72) Inventor: Christopher Mark ALDER, Staines (GB)

(21) Appl. No.: 15/499,213

(22) Filed: Apr. 27, 2017

(30) Foreign Application Priority Data
Apr. 28, 2016 (GB) 1607436.1

(51) Int. Cl. H04N 21/214; H04N 21/647; H04N 21/2662; H04N 21/2381; H04N 21/61; H04N 21/643

(52) U.S. Cl. CPC H04N 21/2143; H04N 21/2662; H04N 21/64738; H04N 21/2381; H04N 21/6118; H04N 21/64322; H04N 21/6131

(57) ABSTRACT

A transmitter and a method for transmitting content over a network is provided. The transmitter includes a user interface configured to select content, a transport stream (TS) encoder configured to convert a format of the selected content into a format that at least one receiver is able to process if the at least one receiver is unable to process the format of the selected content, and package the selected content with the converted format into a TS, and at least one modulator configured to broadcast the selected content packaged into the TS to the at least one receiver.

### CROSS-REFERENCE TO RELATED APPLICATION(S)

This application claims the benefit under 35 U.S.C. §119(a) of a United Kingdom patent application filed on Apr. 28, 2016 in the United Kingdom Patent Office and assigned Serial number GB1607436.1, the entire disclosure of which is hereby incorporated by reference.

### TECHNICAL FIELD

The present disclosure relates to an apparatus and a method for transmitting content over a network. More particularly, the present disclosure relates to a method for managing and updating content more easily in a network.

### BACKGROUND

Televisions (TVs) in hospitality environments may provide services customized for a particular type of business. For example, TVs equipped in hotels may have customized channel lists and TV settings. The TVs also commonly have requirements to show a ‘hotel portal’ (consisting of hotel-specific text/images) that may include guest information and other data on the TV screen.

In many hotel TV systems, the TV configuration described above is shared via a universal serial bus (USB) update. The hotelier will visit each room to equally update the TV in the room. The majority of hotels around the world have a cable-based radio frequency (RF) infrastructure. Further, systems have been developed in which a pre-programmed “seed transport stream” is transmitted over the RF cable network by a dedicated modulator installed in the hotel. A drawback of this system is that the content of the seed transport stream is defined in advance, and cannot easily be updated by the hotelier. Internet protocol (IP) based systems have been developed which offer greater control over content on the hotel portal, however, such systems require the installation of a complex and expensive dedicated IP infrastructure.

Therefore, a need exists for an apparatus and a method for managing and updating content more easily in a network.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for transmitting content over a network.

Another aspect of the present disclosure is to provide an apparatus and a method for managing and updating content more easily in a network.

Another aspect of the present disclosure is to provide an apparatus and a method for providing content in real time without delay.

Another aspect of the present disclosure is to provide an apparatus and a method for providing various services according to a user's selection.

In accordance with an aspect of the present disclosure, a transmitter in a network is provided. The transmitter includes a user interface configured to select content, a transport stream (TS) encoder configured to convert a format of the selected content into a format that at least one receiver is able to process if the at least one receiver is unable to process the format of the selected content, and package the selected content with the converted format into a TS, and at least one modulator configured to broadcast the selected content packaged into the TS to the at least one receiver.

In accordance with another aspect of the present disclosure, a method for transmitting content in a transmitter in a network is provided. The method includes determining whether at least one receiver is able to process a format of selected content, converting a format of the selected content into a format that the at least one receiver is able to process if the at least one receiver is unable to process the format of the selected content, packaging the selected content with the converted format into a TS, and broadcasting the selected content packaged into the TS to the at least one receiver.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other objects, features, and advantages of certain embodiments of the present disclosure will be more apparent from the following description taken in conjunction with the accompanying drawings, in which:

FIG. 1 is a block diagram of a server according to an embodiment of the present disclosure;

FIG. 2 illustrates a system including a transmitter and a receiver according to an embodiment of the present disclosure;

FIG. 3 is a block diagram of a receiver according to an embodiment of the present disclosure;

FIG. 4 is a flowchart illustrating a method for transmitting content according to an embodiment of the present disclosure;

FIG. 5 is a flowchart illustrating an operation of a server in a case that downscaling operation is not selected according to an embodiment of the present disclosure;

FIG. 6 is a flowchart illustrating operation of a server in a case that downscaling operation is selected, according to an embodiment of the present disclosure;

FIG. 7 illustrates a user interface (UI) screen for a single seed stream mode, according to an embodiment of the present disclosure;

FIG. 8 illustrates a UI screen for a multi-channel mode, according to an embodiment of the present disclosure;

FIG. 9 illustrates a dialog box prompting a selection of content for a service, according to an embodiment of the present disclosure; and

FIG. 10 illustrates a UI screen on which a menu for downscaling content is displayed, according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

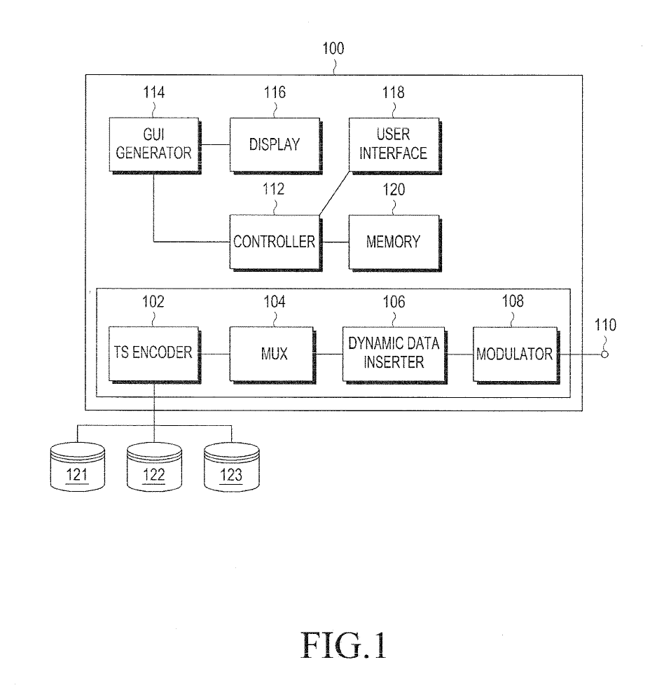

FIG. 1 is a block diagram of a server according to an embodiment of the present disclosure.

Referring to FIG. 1, a server 100, in accordance with an embodiment of the present disclosure, refers to a device for broadcasting transport streams (TSs) over a network. The TS may be comprised of a series of TS packets. The network may be, for example, a private network that represents a closed network in a building, such as a hotel.

The server 100 may include a TS encoder 102, a multiplexer (MUX) 104, a dynamic data inserter 106, a modulator 108, and a radio frequency (RF) output interface 110.

The TS encoder 102 may perform encoding operation to convert content from one format to another format.

The MUX 104 may output a multiplexed TS including content encoded by the TS encoder 102 on a plurality of services.

The dynamic data inserter 106 may insert data into the multiplexed TS.

The modulator 108 may modulate an RF signal to carry the multiplexed TS with the data inserted thereto.

The RF output interface 110 may broadcast the modulated RF signal to one or more receivers included in the network.

The server 100 may further include a controller 112 for controlling the TS encoder 102, the multiplexer 104, the dynamic data inserter 106 and the modulator 108 and controlling overall operation of the server 100.

In an embodiment of the present disclosure, the server 100 may be operated by a user without the use of specialized equipment. For example, the server 100 may be operable by way of a user interface 118, such as a touchscreen, a keyboard, or a mouse.

To allow the user to operate the server 100, a graphical user interface (GUI) generator 114 may generate information about the network, services, content, and status of the server 100 to be presented for the user. A display 116 may then display the information generated by the GUI generator 114 for the user to see the information.

In an embodiment of the present disclosure, any of the GUI generator 114, the display 116 and the user input device 118 may be integrated into the server 100 or may be implemented in the form of a physically separate device from the server 100. For example, the server 100 may be operated via connection to a remote computer which includes the GUI generator 114, display 116 and user input device 118.

The user interface 118 may allow the user to select content stored locally in a memory 120 and/or content stored remotely in one or more external content sources 121, 122, 123, or to modify information currently being broadcast by the server 100. The memory 120 may also store computer program instructions that may be executed by the controller 112.

The content selected by the user may be any media input source. For example, the content may be the Internet protocol (IP) address of a webcam external to the network. Alternatively or additionally, the content may be personal media, such as home movies, recorded content (e.g., personal video recorder (PVR)); or the IP address of local IP content. Alternatively, the content may be rebroadcast content. For example, a signal received from one source, such as a satellite digital video broadcasting—satellite (DVB-S) feed, and rebroadcast in another format, such as a DVB—terrestrial (DVB-T) feed.

The controller 112 may determine whether a selected content may be processed by a device, such as a television (TV) that receives content in an RF signal. For example, video content in a Windows Media format may be converted to a moving picture experts group (MPEG)-2 TS format or a H262 TS format so that it may be processed by the TV. If the selected content is not in a format that may be processed by the TV, the controller 112 may control the TS encoder 102 to transcode the selected content into an appropriate format. By transcoding the content if necessary, the server 100 does not need to be a high power device, and may be optimized to do the minimum possible processing.

The TS encoder 102 may then package the transcoded content into a TS. In other words, the TS encoder 102 may generate a seed TS. For greater efficiency and performance, the transcoding of static files may be performed in advance. If the selected content is in a format that may be processed by the TV, the TS encoder 102 may then package the selected content into a TS without transcoding.

In some embodiments of the present disclosure, the controller 112 may determine whether there is enough bandwidth to broadcast the selected content in a frequency channel over which the modulated RF signal is to be transmitted, based on the known upper bitrate of the receivers (such as TVs) on the network. If there is not enough bandwidth, the controller 112 may control the GUI generator 114 to display a message for the user's selection on the display 116. The message may be one to prompt the user to choose to downscale the content (e.g., from a High Definition service to a Standard Definition service) or to select different content. The message may also indicate the total bandwidth capacity and remaining bandwidth capacity of the frequency channel.

The server 100 may multiplex a transcoded TS including a plurality of service signals, i.e., services signals #1 to #N 208a-208c using the multiplexer 104. Each content or media source relates to a service provided by the server 100, and each of the service signals may include content.

The MUX 104 may multiplex the whole TS into a multi-channel MPEG 2 DVB and advanced TV system committee (ATSC) compliant TS. In other words, the MUX 104 may output a compliant seed TS that may be decoded by any DVB or ATSC TV. In other embodiments of the present disclosure, the MUX 104 may be configured to output a multi-channel TS that may be processed by one of a DVB or an ATSC TV.

The multiplexed TS may then be passed to a dynamic data inserter 106. The dynamic data inserter 106 may insert data into the multiplexed TS. Preferably, the data may be added to the multiplexed TS. Alternatively, the dynamic data inserter 106 may insert the data before the TS is multiplexed.

The data may include, for example, program specific information, such as a user-defined channel and event names. The data may include files stored on a digital storage media command and control (DSM-CC) data carousel.

The dynamic data inserter 106 may then stream a buffer of TS sections to the modulator 108. If the modulator 108 is configured in the plural, the dynamic data inserter 106 may stream a buffer of TS sections to the plurality of modulators 108. The data may include dynamic data, such as weather information, flight information, channel list, guest data, or a hotel portal. By using the dynamic data inserter 106 in this way, data received by the user may be updated automatically without having to regenerate the whole TS. The dynamic data inserter 106 may, for example, insert the data into DVB/ATSC metadata, such as the event information table (EIT).

The modulator 108 may be a software-implemented driver. The modulator 108 may broadcast packets (packaged content) based on user-defined modulation parameters. The modulation parameters define a frequency channel. The modulator 108 may create a plurality of frequency channels for broadcasting the selected content through the RF output interface 110. One of the plurality of frequency channels may be a dedicated ‘home channel’, i.e. an MPEG2 TS (ATSC or DVB) added to the network's RF feed. Devices on the network may then be able to scan the home channel, in addition to any of the other created frequency channels. The data inserted by the dynamic data inserter 106 may be a computer program that the receiver may download and install when it tunes to an associated frequency channel.

In an embodiment of the present disclosure, the RF output interface 110 may be a cable interface, such as a co-axial RF cable interface. In another embodiment of the present disclosure, the RF output interface 110 may be an aerial for over-the-air broadcasting.

Using the user interface 118, the user is able to schedule content to be delivered on any of the created frequency channels. For example, the user could configure a service so that it will play content at different times in a day, or repeat at certain intervals. Each service has its own independent schedule window. Alternatively, the server 100 may be configured to prepare the content (transcode and convert the container format) in advance, in order to reduce the risk of play out delays.

While the described embodiment illustrates multi-channel streaming by way of the MUX 104, it would be readily understood that in other embodiments single-channel streaming is preterable. In the other embodiments of the present disclosure, the MUX 104 is not necessary, and the dynamic data inserter 106 may insert data into the TS packaged by the encoder 102. In some embodiments of the present disclosure, the user may select a plurality of content, even from different sources, and create a single service showing all of them as a mosaic.

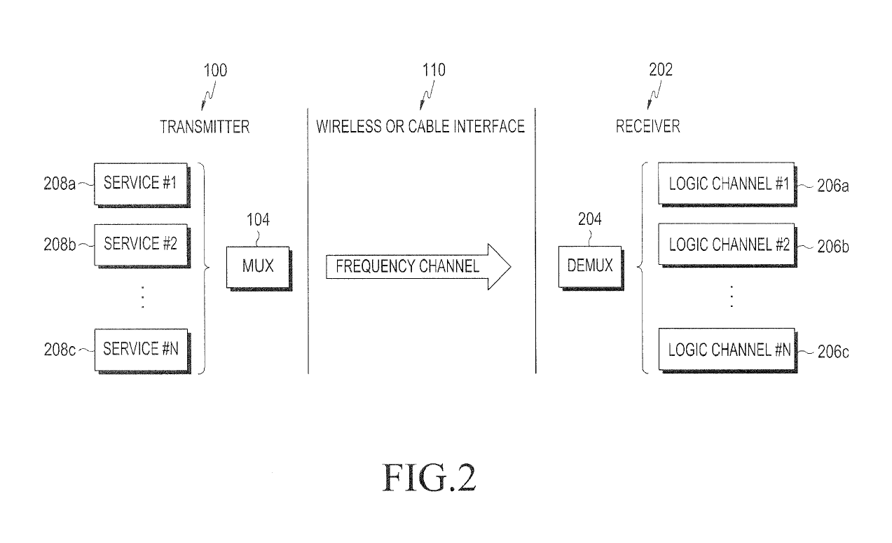

FIG. 2 illustrates a system including a transmitter and a receiver in a network according to an embodiment of the present disclosure.

Referring to FIG. 2, the transmitter may act as the server 100 as described above. A receiver 202 may be a device for receiving TSs broadcast from the server 100, e.g., a TV.

There may be a frequency channel between the transmitter 100 and the receiver 202, and the transmitter 100 may broadcast a TS in the frequency channel. Although a single frequency channel is shown in FIG. 2, it would be readily understood that the transmitter 100 could broadcast a plurality of TSs in a plurality of frequency channels. The transmitter 100 and the receiver 202 may include an interface for transmitting/receiving a broadcast TS. For example, the interface may include a wireless or cable interface.

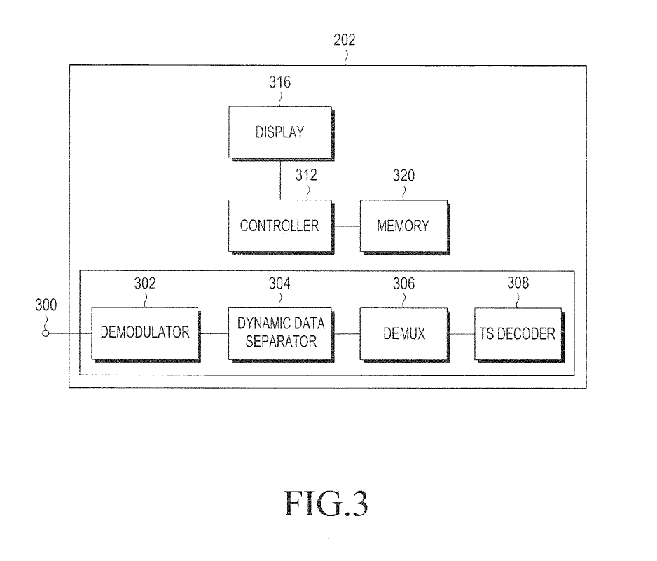

In the meantime, in the case that there are a plurality of frequency channels, each of the plurality of frequency channels may support a plurality of services 208a, 208b, 208c. Each of the plurality of services 208a, 208b, 208c is associated with a different content. The receiver 202 may include a demultiplexer (DEMUX) 204 for converting the demodulated TS received on the tuned frequency channel into a plurality of logical channels 206a, 206b, 206c that may be selected by a user. The internal configuration of the receiver 202 will now be described with reference to FIG. 3.

FIG. 3 is a block diagram of a receiver according to an embodiment of the present disclosure.

Referring to FIG. 3, the receiver 202 may include an RF input interface 300, a demodulator 302, a dynamic data separator 304, a DEMUX 306, and a TS decoder 308.

The RF input interface 300 may receive an RF signal broadcast from the server 100.

The demodulator 302 may detect a TS which is demodulated from the RF signal and then multiplexed.

The dynamic data separator 304 may separate data from the multiplexed TS detected by the demodulator 302.

The DEMUX 306 may demultiplex the multiplexed TS with the data separated therefrom, and output a number of TSs.

The TS decoder 308 may decode each of the number of TSs.

In the meantime, the receiver 202 may further include a controller 312, a display 316, and a memory 320. The controller 312 may control the RF input interface 300, the demodulator 302, the dynamic data separator 304, the DEMUX 306, the TS decoder 308, a display 316, and a memory 320, and control overall operation of the receiver 202.

The display 316 may display the decoded TS under the control of the controller 312. The displayed TS may be selected by the user, and for this, the receiver 202 may further include a user interface although not shown in FIG. 3. The memory 320 may store various information created during operation of the receiver 202, e.g., decoded TSs, information about user settings, and the like.

A method of transmitting content in the server 100 in accordance with an embodiment of the present disclosure will now be described.

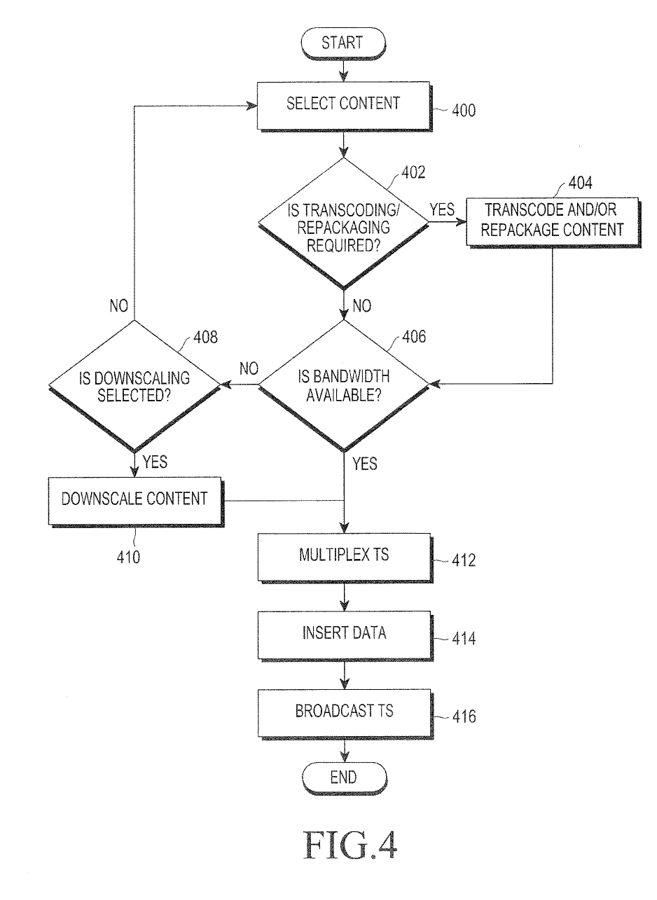

FIG. 4 is a flowchart illustrating a method for transmitting content, according to an embodiment of the present disclosure.

Referring to FIG. 4, the server 100 receives a user selection of content, in operation 400. In this regard, the server 100 displays information for content selection on the display 116, and receives a selection of content from the user through the user interface 118.

The server 100 determines whether transcoding and/or repackaging of the selected content is required, in operation 402. Transcoding of the selected content is required if the selected content is not in a format that may be processed by the receiver 202. Similarly, repackaging of the selected content is required if the selected content is not in a container structure that may be understood by the receiver 202. For example, the receiver 202 may receive and reproduce video content that is encoded in a particular format, e.g., the H.262 format and packaged in a particular container structure, e.g., an MPEG-2 TS.

If transcoding and/or repackaging of the selected content is required, the server 100 transcodes and/or repackages the selected content, in operation 404. Specifically, the server 100 converts the selected content to a format that may be processed by the receiver 202 by transcoding and/or repackaging the selected content.

If neither transcoding nor repackaging of the selected content is required, or after the selected content has been transcoded and/or repackaged, in operation 406 the server 100 determines whether sufficient bandwidth is available to transmit the selected content to the receiver 202. In other words, the server 100 determines whether there is enough bandwidth to broadcast the selected content.

Operation 406 may take place before the selected content is transcoded, to further reduce the processing overhead. In some embodiment of the present disclosure, the server 100 may already be broadcasting service signals 208a, 208b, 208c, and so the server 100 may determine the remaining bandwidth available to be allocated to a new service signal, and determine whether the remaining bandwidth is sufficient to transmit the selected content in the new service.

In some embodiments of the present disclosure, if the server 100 determines that there is not enough bandwidth to transmit the selected content, a menu may be displayed to give the user an option to downscale the selected content or to select new content. The server 100 may also display a menu that gives an option to release the selection of the selected content. The server 100 may also display a message informing that there is not enough bandwidth to transmit the selected content. In addition to the method for displaying the aforementioned menus, information, or messages, it is also possible to inform the user of the aforementioned menu, information or message in voice.

In the meantime, depending on the displayed menu, the server 100 may receive the user's selection. If, in operation 408, the user selects not to downscale the selected content, the server 100 returns to operation 400 to receive a selection of content from the user. For this, the server 100 displays information for content selection on the display 116.

If the user selects to downscale the selected content, the server 100 downscales the selected content in operation 410. The selected content may be downscaled using a compression algorithm. Alternatively, an algorithm may be configured to automatically select a suitable compression ratio based on a current bitrate of the selected content and an amount of available bandwidth. Alternatively, a default compression ratio or a user-selected compression ratio may be used when downscaling the selected content.

After downscaling the selected content, the server 100 returns to operation 406 to determine whether the downscaled content may be transmitted based on the available bandwidth. The server 100 then multiplexes TSs in operation 412. Specifically, the server 100 multiplexes TSs for a plurality of services including packaged content through the MUX 104 and outputs a compliant seed TS that may be decoded by a particular DVB or ATSC TV.

The server 100 inserts data into the seed TS through the dynamic data inserter 106, in operation 414. The data may be, for example, weather data, flight data, or specific data on the network. The server 100 then modulates the seed TS including the data and broadcast the modulated seed TS, in operation 416. The modulated seed TS may be broadcast in a packet format (in a packaged content) based on user-defined modulation parameters. The modulated seed TS may be broadcast on a frequency channel through a wireless or cable interface.

The receiver 202 may receive the content broadcast on the frequency channel by tuning in the frequency channel. It may also receive the content broadcast on the frequency channel in the private network in the same way as it would be performed for a frequency channel broadcast on an external network.

In other words, the receiver 202 may be configured for use on a network using an RF transmission and reception, without the need for complex tools or specialist knowledge. Received content may also be updated dynamically, for example with new weather or flight information, without the need for a user to control the server 100 and without the receiver 202 experiencing a temporary loss of service.

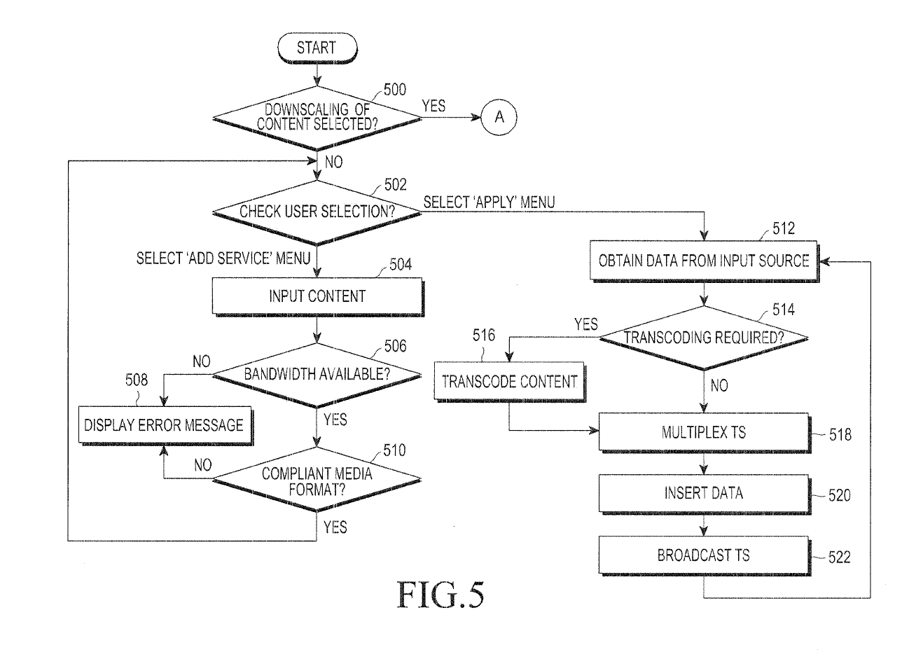

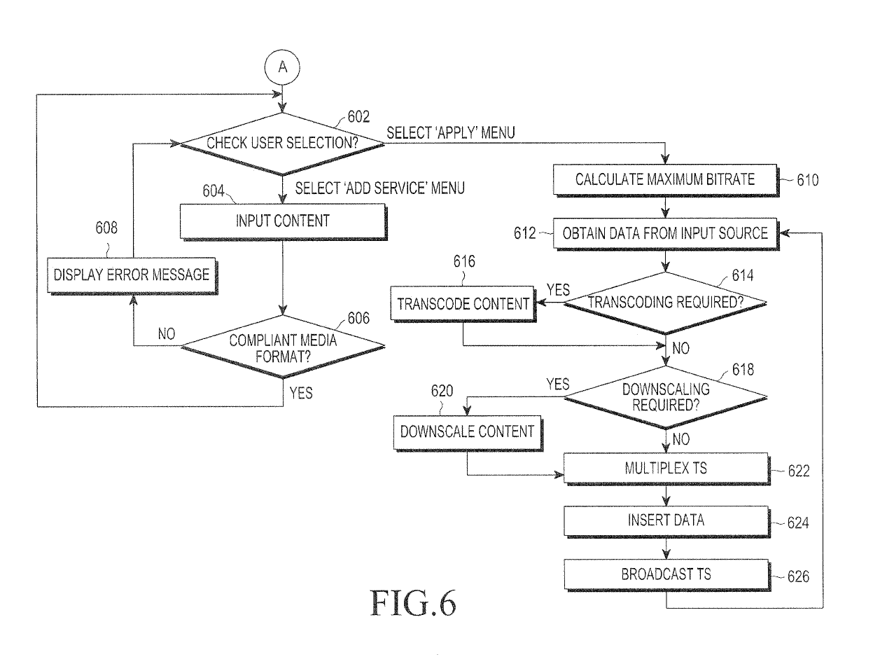

In accordance with an embodiment of the present disclosure, two operations may be performed separately based on whether the downscaling operation is selected. Operations of the server 100 in a case that downscaling operation is not selected and in a case that downscaling operation is selected will now be examined with reference to FIGS. 5 and 6, respectively.

FIG. 5 is a flowchart illustrating operation of a server in a case that downscaling operation is not selected according to an embodiment of the present disclosure.

Referring to FIG. 5, the server 100 determines whether a downscaling content menu has been selected, in operation 500. For example, the server 100 displays a menu giving an option to select whether to downscale content, and based on the user's input, determines whether the downscaling content menu has been selected. The fact that the downscaling content menu has been selected indicates that downscaling operation has been selected, and specifically, that downscaling operation will be performed on the content based on availability of the bandwidth.

The server 100 proceeds to operation “A” if the downscaling content menu is selected. Operation “A” will be described with reference to FIG. 6. The server 100 goes to operation 502 to determine the user's selection if the downscaling content menu is not selected. The user's selection refers to a selection related to adding content to be served, and if the user intends to add content, “add service” menu may be selected, and if the user intends not to add content but to maintain and broadcast the service for the existing content, “apply” menu may be selected.

If it is determined in operation 502 that the user has selected the “add service” menu is selected, the server 100 receives an input content from the user in operation 504 and proceeds to operation 506. For example, the server 100 receives the URL or file for the content to be added through the user interface 118. The server 100 then determines whether the bandwidth is available to transmit the received content, in operation 506. If the bandwidth is not available, the server 100 proceeds to operation 508 to display an error message and returns to operation 502 to receive the user's selection.

On the other hand, if the bandwidth is available, the server 100 proceeds to operation 510 to determine whether the received content is in a compliant media format. Being in the compliant media format means that the format of the received content may be decoded in the receiver 202. If the received content is not in the compliant media format, the server 100 proceeds to operation 508 to display an error message and returns to operation 502 to receive the user's selection.

On the other hand, if the received content is in the compliant media format, the server 100 proceeds to operation 502. If it is determined in operation 502 that the user has selected the “apply” menu, the server 100 obtains data from an input source, in operation 512. The server 100 determines based on the obtained data whether transcoding of the received content is required, in operation 514. If it is determined that the transcoding is required, the server 100 transcodes the received content in operation 516. On the other hand, if it is determined that the transcoding is not required, the server 100 performs TS multiplexing on the received content and outputs a compliant seed TS to the receiver 202, in operation 518.

The server 100 then adds data to the seed TS, in operation 520. The data may be, for example, weather data, flight data, or specific data on the network. The server 100 modulates the seed TS including the data, and broadcasts the modulated seed TS, in operation 522.

Next, operations after operation “A”, which are performed in the case that the downscaling content menu is selected in operation 500 of FIG. 5, will be described with reference to FIG. 6.

FIG. 6 is a flowchart illustrating operation of a server in a case that downscaling operation is selected according to an embodiment of the present disclosure.

Referring to FIG. 6, the server 100 proceeds to operation 602 to determine the user's selection if the downscaling content menu is selected. The user's selection refers to a selection related to adding content to be served, and if the user intends to add content, “add service” menu may be selected, and if the user intends not to add content but to maintain and broadcast the service for the existing content, “apply” menu may be selected.

If the “add service” menu is selected, the server 100 proceeds to operation 604 to receive content from the user. For example, the server 100 receives the URL or file for the content to be added through the user interface 118. The server 100 then determines whether the received content is in a compliant media format, in operation 606. Being in the compliant media format means that the format of the received content may be decoded in the receiver 202. If the received content is not in the compliant media format, the server 100 proceeds to operation 608 to display an error message and returns to operation 602 to receive the user's selection.

On the other hand, if the received content is in the compliant media format. the server 100 proceeds to operation 602. If it is determined in operation 602 that the user has selected the “apply” menu, the server 100 proceeds to operation 610. In operation 610, the server 100 calculates a maximum bitrate. The server 100 then obtains data from an input source, in operation 612. The server 100 determines based on the obtained data whether transcoding of the received content is required, in operation 614. If it is determined that the transcoding is required, the server 100 transcodes the received content in operation 616. On the other hand, if it is determined that the transcoding is not required, the server 100 proceeds to operation 618 to determine whether the received content requires downscaling.

If it is determined that the downscaling is required, the server 100 downscales the received content in operation 620. The server 100 then performs TS multiplexing on the received content and outputs a compliant seed TS to the receiver 202, in operation 622.

The server 100 then adds data to the seed TS, in operation 624. The data may be, for example, weather data, flight data, or specific data on the network. The server 100 modulates the seed TS including the data, and broadcasts the modulated seed TS, in operation 626.

User interface (UI) screens in accordance with embodiments of the present disclosure will now be examined.

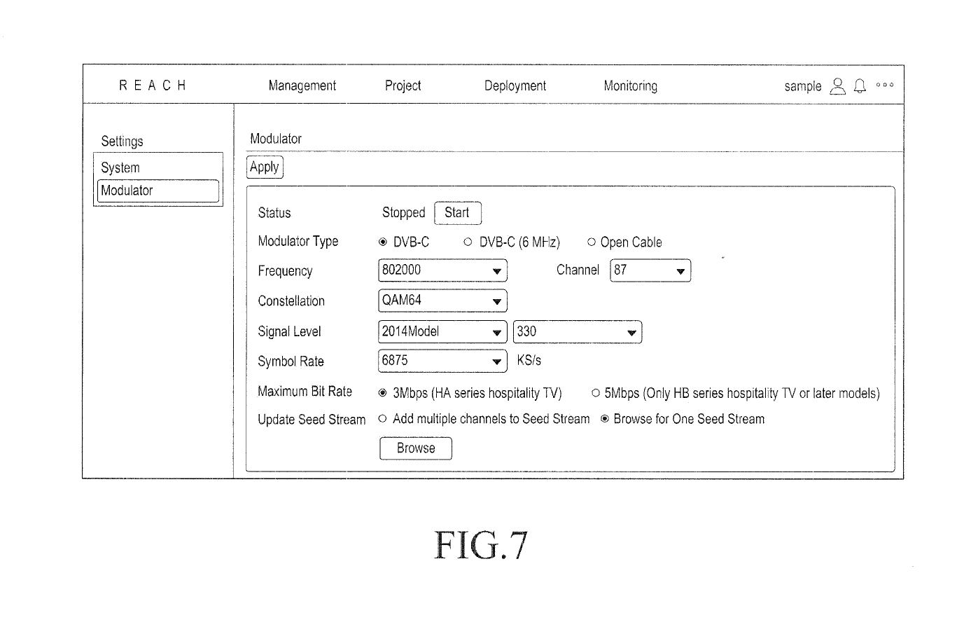

FIG. 7 illustrates a UI screen for a single seed stream mode according to an embodiment of the present disclosure.

The server 100 may use a program or application app to receive the user's selection in relation to the method in accordance with the aforementioned embodiments of the present disclosure. In this regard, a UI screen may be displayed on the display 116 of the server 100, as shown in FIG. 7.

Referring to FIG. 7, if modulator menu is selected as a menu to configure information for operation of the server 100, menus allowing the user to select and input a number of pieces of information are displayed. Specifically, ‘status’ menu may include “stop” and “start” as options to respectively stop and start operation of the server 100 based on the information configured in the modulator menu.

Modulator type menu may include options to select types of modulation. For example, modulation types corresponding to “DVB-C”, “DVB-C (6 MHz)” and “Open Cable” may be included as options.

Frequency menu and channel menu may include options to select frequencies and channels, respectively. Constellation menu may include options to select modulation methods, and signal level menu may include options to select signal types and levels.

Furthermore, symbol rate menu may include options to select the number of symbols to be transmitted per second (modulation rate), and maximum bit rate menu may include options to select the number of bits to be transmitted in a unit time.

Update seed stream menu may include two options as menus to select “single seed stream mode” and “multi-channel mode”. Specifically, the update seed stream menu may include “add multiple channels to seed stream” as an option to add a plurality of channels to a single seed stream, and “browse for one seed stream” as an option to generate a single seed stream. In the embodiment of FIG. 7, an occasion when the “browse for one seed stream” is selected is shown. In the case that the “browse for one seed stream” is selected, a browse button is activated, and the user may input a URL of the content to be added by pressing the browse button or upload a content file stored in the server 100 through navigation operation.

As described above, once information about the presented menus is all selected or inputted, the user may select the apply menu allowing the information to be used as configured information for broadcasting operation.

In the meantime, the seed stream output in the single seed stream mode may be a compliant seed stream (e.g., a compliant DVB or ATSC MPEG seed stream) for the receiver 202. For example, the seed stream may be a TS compliant to the environment of the receiver 202. In the single seed stream mode, the user may select a seed TS in which a plurality of services are already defined, so it is not necessary to be the single channel TS. In the single seed stream mode, however, a service may not be dynamically added or deleted.

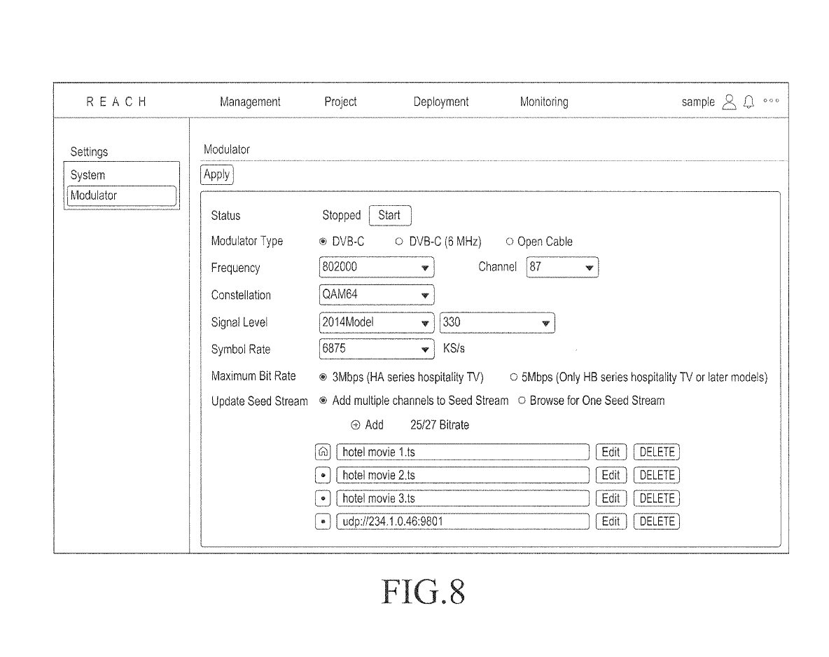

FIG. 8 illustrates a UI screen for a multi-channel mode according to an embodiment of the present disclosure.

The UI screen shown in FIG. 8 is the same as the UI screen shown in FIG. 7 except that an option selected from the update seed stream menu is different. In FIG. 8, a UI screen is shown in the case that “add multiple channels to seed stream” is selected from the update seed stream menu.

Referring to FIG. 8, if the “add multiple channels to seed stream” is selected, “add” menu that may add content may be activated. The user may select the “add” menu to add multiple contents, and may modify or delete each of the added contents using “edit” and “delete” menus. Such operations may be performed in real time.

Bitrate information is displayed next to the “add” menu. The bitrate information may be modified according to the added content, and adding content may be limited based on the bitrate information. In other words, if the bitrate would be exceeded by adding certain content, the content may not be added.

With the menus, all media content compliant to the receiver 202, e.g., single channel MPEG2 TS, MP4 or IP content may be added to a service. The server 100 may automatically convert the added content into a format that may be decoded by the TV, e.g., MPEG2 TS or H.264. The server 100 may also output a TS that may be decoded in the receiver 202, e.g., DVB/ATSC TS, by multiplexing a number of services together.

In the embodiment of FIG. 8, an occasion when the user selects one IP source and three single channel TSs is shown. The user may select other media formats, such as mp4 files. In some embodiments of the present disclosure, only a special file format, such as a TS file and an IP file may be allowed, and transcoding may be automatically performed.

The used bitrate and maximum available bitrate may be automatically displayed. In FIG. 8, as an example, the maximum available bitrate is 27 Mb/s and the used bitrate is 25 Mb/s.

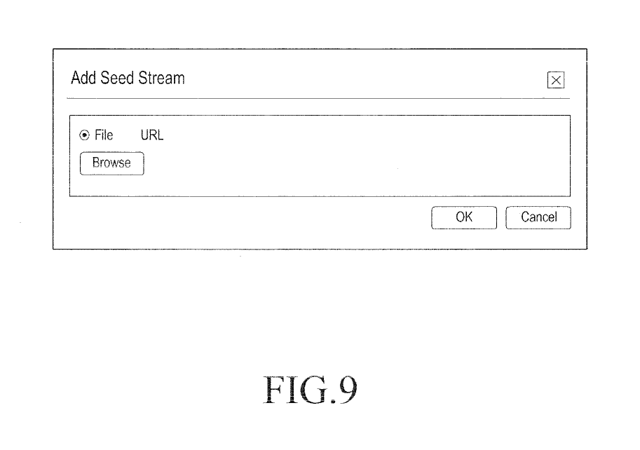

FIG. 9 illustrates a dialog box prompting a selection of content for a service according to an embodiment of the present disclosure.

Referring to FIG. 9, in the UI screen shown in FIG. 8, once the “add” menu is selected, a dialog box may be displayed as shown in FIG. 9. In the dialog box, options for the user to select a format of content to be added, e.g., file and uniform resource locator (URL), and a browse button to for the user to navigate files stored in the server 100 may be displayed. Buttons for the user to determine whether to actually add content, e.g., OK and cancel buttons, may also be displayed. The UI that may receive a selection of content from the user is not limited to the format of the dialog box as shown in FIG. 9 but may be implemented in various forms.

There are physical limitations on the volume of data to be transmitted on a frequency channel. For example, DVB-C and Open Cable channels may support higher bitrate than the DVB-T channel does, i.e., about twice the volume. The DVB-C MPEG2 TS channel theoretically has the maximum bitrate of about 51 Mbps, while the DVB-C channel has the maximum bitrate of about 40 Mbps and the Open Cable channel has the maximum bitrate of about 34 Mbps. If the channel has more than the maximum bitrate, the displayed screen may crack.

Accordingly, the whole maximum bitrate may be restricted according to an embodiment of the present disclosure. For example, if the maximum bitrate is restricted to about 34 Mbps, the server 100 may reserve about 7 Mbps for dynamic data to be transmitted from the DSM-CC conveyer, e.g., a project, firmware, weather information, and the like, and use the remaining 27 Mbps for transmission of content.

Management and setting of an available bitrate may be determined by the user or predefined. The following Table I illustrates typical bitrates for the respective DVB-C contents.

TABLE 1

| Resolution | Typical Bitrate | |
|---|---|---|
| UHD content (4K) | 25 | Mbps |
| FHD content (1080P) | 12 | Mbps |
| HD content (720p) | 4 | Mbps |
| SD content (360p) | 2 | Mbps |
| Note that REACH will treat all IP streams | | |
| as SD content | | |

Depending on the restricted maximum bit rate, there are several limitations on the number of channels that may be added. For example, depending on the maximum bitrate, a single ultra high definition (UHD) channel may be added, or two full high definition (FHD) channels or 6 HD channels may be added.

In the meantime, some users may prefer to support more digital television (DTV) services even though the image quality would be degraded. As such, in a case of intending to support more services, the user may reduce the bitrate of each service.

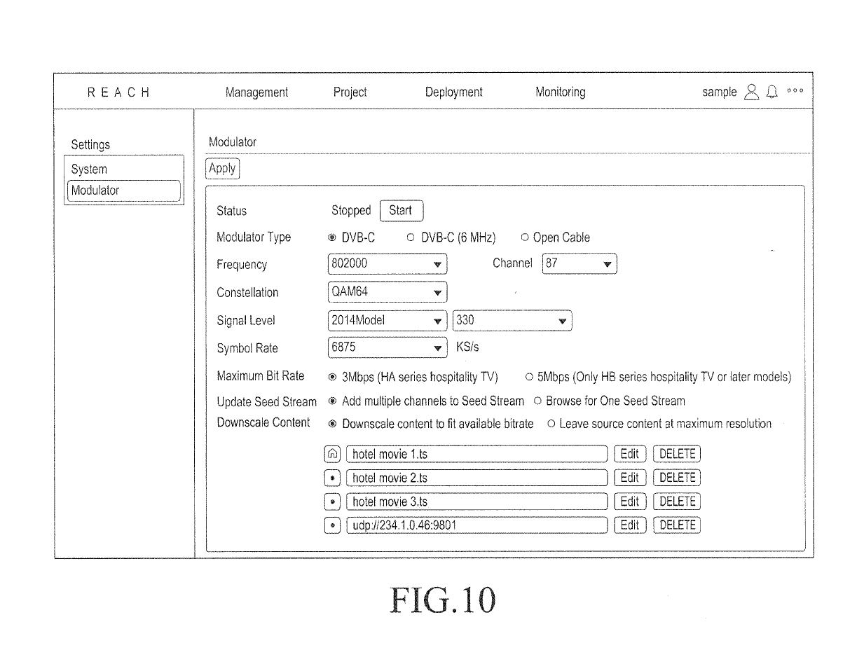

For this, a menu allowing the user to select content downscaling may be provided for the user. Once the content downscaling is selected, information about the available bitrate may not be displayed any longer. Instead, the user may add more services than when the content downscaling is not selected, and select input media for the respective services. An associated UI is shown in FIG. 10.

FIG. 10 illustrates a UI screen on which a menu for downscaling content is displayed according to an embodiment of the present disclosure.

Referring to FIG. 10, “downscale content” menu may be additionally displayed on the same UI screen shown in FIG. 8. The “downscale content” menu is to allow downscaling of content to be selected, including two options like “downscale content to fit available bitrate” and “leave source content at maximum resolution”.

The server 100 automatically downscales the size of input content (i.e., adjust the bitrate) to fit an available bitrate. For example, if the user selects 10 services, the server 100 calculates a maximum permissible bitrate for each service, e.g., 27 Mbps/10=2.7 Mbps.

Since the input stream has a fixed bitrate, the server 100 determines the bitrate of the input content once after the user selects the content. Some channels may be lower than a maximum bitrate that is already allowed. In this case, extra bitrate capacity may be used in another stream, and accordingly the maximum permissible bitrate may be adjusted.

The server 100 may automatically transcode the input content in real time, and if necessary, may adjust the bitrate to make all channels have a bitrate below a threshold. This enables more channels to be used even though the image quality is degraded.

If the user selects to preserve the existing bitrate and resolution, the server 100 calculates a bitrate after the user adds a new service. The server 100 displays an error message if the total bit rate of all the services exceeds the capacity. The server 100 transcodes the input content (e.g., converts it to an MPEG2 TS), but does not adjust the bitrate. The input sources are multiplexed together and then broadcast. Contents for the respective services are transcoded and re-multiplexed in real time. This may allow transcoding of IP content from a live source.

In the meantime, if the user selects to dynamically reduce the existing bitrate and resolution, the server 100 calculates a maximum available bitrate based on the number of channels and a bitrate of each input source. If the user selects to apply the settings and start broadcasting, the server 100 transcodes the input content (e.g., converts it to an MPEG2 TS) and adjusts a bitrate of each service content to be less than a calculated threshold, i.e., the maximum available bitrate. Transcoding and downscaling may be performed in a single operation or in separate operations. The input sources are multiplexed together and then broadcast e.g., in an MPEG TS. The transcoding and downscaling allows live streaming from IP sources and eliminates delay, and may, accordingly, be performed in real time.

According to an embodiment of the present disclosure, content may be locally generated and changed without involving a third party, such as an expert. Moreover, content may be managed and updated more easily and provided in real time without delay. In addition, various services may be provided according to the user's selection, bringing cost effectiveness.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A transmitter in a network, the transmitter comprising:
a user interface for selecting content;
a transport stream (TS) encoder configured to:
convert a format of the selected content into a format that at least one receiver is able to process if the at least one receiver is unable to process the format of the selected content, and
package the selected content with the converted format is converted, into a TS; and
at least one modulator configured to broadcast the selected content packaged into the TS to the at least one receiver.

2. The transmitter of claim 1, wherein the selected content packaged into the TS is broadcast based on a radio frequency (RF) transmission scheme.

3. The transmitter of claim 1, further comprising:
a TS multiplexer configured to multiplex the selected content packaged into the TS into a multiplexed TS including a plurality of service signals,
wherein the TS broadcast by the at least one modulator comprises the multiplexed TS.

4. The transmitter of claim 3, further comprising:
a dynamic data inserter configured to insert data into the multiplexed TS.

5. The transmitter of claim 4, wherein the data comprises at least one of:
channel information, broadcast program information, information about an installable computer program for the at least one receiver, or information about files stored in the network.

6. The transmitter of claim 1, wherein the selected content comprises content received from at least one internet protocol (IP) source.

7. The transmitter of claim 1, further comprising:
a display; and
at least one processor configured to:
calculate available bandwidth after the selected content with the converted format is packaged into the TS, and
output information about the calculated available bandwidth to the display.

8. The transmitter of claim 1, further comprising:
at least one processor configured to downscale the selected content, if broadcasting of the selected content requires greater bandwidth than the available bandwidth.

9. The transmitter of claim 1, wherein the at least one modulator is further configured to broadcast the selected content packaged into the TS on a plurality of frequency channels.

10. The transmitter of claim 1, wherein the at least one modulator is further configured to broadcast the selected content packaged into the TS over at least one of a wireless interface or a cable interface.

11. A method for transmitting content in a transmitter in a network, the method comprising:
determining whether at least one receiver is able to process a format of selected content;
converting a format of the selected content into a format that the at least one receiver is able to process if the at least one receiver is unable to process the format of the selected content;
packaging the selected content with the converted format into a transport stream (TS); and
broadcasting the selected content packaged into the TS to the at least one receiver.

12. The method of claim 1, wherein the selected content packaged into the TS is broadcast based on a radio frequency (RF) transmission scheme.

13. The method of claim 11, wherein the selected content packaged into the TS is multiplexed into a multiplexed TS including a plurality of service signals, and the broadcast TS comprises the multiplexed TS.

14. The method of claim 13, further comprising inserting data to the multiplexed TS.

15. The method of claim 14, wherein the data comprises at least one of:
channel information, broadcast program information, information about an installable computer program for the at least one receiver, or information about files stored in the network.

16. The method of claim 11, wherein the selected content comprises content received from at least one internet protocol (IP) source.

17. The method of claim 11, further comprising:
calculating available bandwidth after the selected content with the converted format is packaged into the TS; and
outputting information about the calculated available bandwidth to a display.

18. The method of claim 11, further comprising:
downscaling the selected content, if broadcasting of the selected content requires greater bandwidth than the available bandwidth.

19. The method of claim 11, wherein the selected content packaged into the TS is broadcast on a plurality of frequency channels.

20. The method of claim 11, wherein the selected content packaged into the TS is broadcast over at least one of a wireless interface or a cable interface.
